(19) United States
(12) Patent Application Publication
(10) Pub. No.: US 2025/0294180 A1
(43) Pub. Date: Sep. 18, 2025

(54) Method and Apparatus for Decoder-Side Motion Derivation in Video Coding System

(71) Applicant: MEDIATEK INC., Hsinchu City (TW)

(72) Inventors: Man-Shu CHIANG, Hsinchu City (TW); Chih-Wei HSU, Hsinchu City (TW)

(21) Appl. No.: 18/860,219

(22) PCT Filed: Apr. 17, 2023
(86) PCT No.: PCT/CN2023/088610

§ 371 Date: Oct. 25, 2024

Related U.S. Application Data
(60) Provisional application No. 63/336,378, filed on Apr. 29, 2022.

(51) Int. Cl. H04N 19/52; H04N 19/105; H04N 19/132; H04N 19/139; H04N 19/154; H04N 19/176; H04N 19/182

(52) U.S. Cl. CPC H04N 19/52; H04N 19/105; H04N 19/132; H04N 19/139; H04N 19/154; H04N 19/176; H04N 19/182

(57) ABSTRACT

A method and apparatus for video coding. According to this method, at least one of a first MVP and a second MVP for the current block is determined. At least one of a first MVD associated with the first MVP and a second MVD associated the second MVP from at least one pre-defined set of MVD candidates is determined based on matching costs. Each of the matching costs is determined between neighbouring samples of the current block and predicted samples from corresponding neighbouring samples of each reference block associated with a candidate of said at least one pre-defined set of MVD candidates. The current block is encoded or decoded by using motion information comprising at least one of a first final MV associated with the first MVP and the first MVD, and a second final MV associated with the second MVP and the second MVD.

### CROSS REFERENCE TO RELATED APPLICATIONS

The present invention is a non-Provisional Application of and claims priority to U.S. Provisional Patent Application No. 63/336,378, filed on Apr. 29, 2022. The U.S. Provisional Patent Application is hereby incorporated by reference in its entirety.

### FIELD OF THE INVENTION

The present invention relates to video coding system. In particular, the present invention relates to reduce the signalling overhead related to MVD (MV Difference) for MVP (Motion Vector Predictor) by using template matching.

### BACKGROUND

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology-Coded representation of immersive media-Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video coding system incorporating loop processing. For Intra Prediction, the prediction data is derived based on previously coded video data in the current picture. For Inter Prediction 112, Motion Estimation (ME) is performed at the encoder side and Motion Compensation (MC) is performed based of the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

In video coding, MVD (MV Difference) between a final MV and an MVP (MV Predictor) is signalled. A system may use more MVDs to improve coding performance. However, more MVDs will require more signalling overhead. In the present invention, template matching is used to help reduce signalling overhead associated with MVD for one or more MVPs (MV Predictors).

### BRIEF SUMMARY OF THE INVENTION

A method and apparatus for video coding are disclosed. According to this method, data associated with a current block at an encoder side or coded data associated with the current block to be decoded at a decoder side are received. The current block is coded using uni-prediction or bi-prediction. At least one of a first MVP (Motion Vector Predictor) and a second MVP for the current block is determined. At least one of a first MVD (MV Difference) associated with the first MVP and a second MVD associated the second MVP is determined from at least one pre-defined set of MVD candidates based on matching costs. The matching costs are derived dependent on whether the current block is coded using uni-prediction or bi-prediction. If the current block is coded using the uni-prediction, each of the matching costs is determined between one or more neighbouring samples of the current block and one or more predicted samples from one or more corresponding neighbouring samples of each reference block pointed by a uni-prediction candidate MV based on a candidate of said at least one pre-defined set of MVD candidates and one of the first MVP and the second MVP. If the current block is coded using the bi-prediction, each of the matching costs is determined between one or more neighbouring samples of the current block and one or more predicted samples from one or more corresponding neighbouring samples of each reference block pointed by a bi-prediction candidate MV based on at least first MVP, the second MVP, and a candidate of said at least one pre-defined set of MVD candidates. The current block is encoded or decoded by using motion information comprising at least one of a first final MV associated with the first MVP and the first MVD, and a second final MV associated with the second MVP and the second MVD.

In one embodiment, in response to the current block being coded using the uni-prediction, the uni-prediction candidate MV achieving a smallest matching cost is selected to derive said at least one of the first final MV and the second final MV.

In one embodiment, in response to the current block being coded using the bi-prediction, the bi-prediction candidate MV achieving a smallest matching cost is selected to derive said at least one of the first final MV and the second final MV.

In one embodiment, in response to the current block being coded using the uni-prediction, said at least one pre-defined set of MVD candidates corresponds to only one pre-defined set of MVD candidates used for deriving the uni-prediction candidate MV in list 0 or list 1.

In one embodiment, in response to the current block being coded using the bi-prediction, said at least one pre-defined set of MVD candidates corresponds to only one pre-defined set of MVD candidates used for deriving the bi-prediction candidate MV.

In one embodiment, in response to the current block being coded using the bi-prediction, said at least one pre-defined set of MVD candidates corresponds to two separate pre-defined sets of MVD candidates used for deriving list 0 MV in the bi-prediction candidate MV in and list 1 in the bi-prediction candidate MV respectively.

In one embodiment, in response to the current block being coded using the uni-prediction or the bi-prediction, one or more candidates in said at least one pre-defined set of MVD candidates are derived from an initial MVD.

In one embodiment, the initial MVD for list 0 or list 1 is signalled or parsed. In another embodiment, said at least one pre-defined set of MVD candidates comprises one or more candidate members determined based on one or more signs of the initial MVD, one or more values of the initial MVD or both. In one embodiment, said one or more signs of the initial MVD correspond to plus sign and minus sign. In another embodiment, said one or more values of the initial MVD correspond to k*(the initial MVD) or 0, and wherein k corresponds to N or 1/N, and N is a positive integer. In another embodiment, said one or more values of the initial MVD correspond to (the initial MVD)±b, and wherein b corresponds to an integer or a fractional number.

In one embodiment, said at least one pre-defined set of MVD candidates comprises one or more candidate members determined based on one or more signs of the initial MVD, and wherein a sign for a target MVD candidate is determined from said at least one pre-defined set of MVD candidates based on the matching costs. In one embodiment, a value for the target MVD candidate is predefined. In another embodiment, a value for the target MVD candidate is signalled or parsed. In yet another embodiment, one or more syntaxes related to the value for the target MVD candidate are signalled or parsed at a block level, SPS-level, PPS-level, APS-level, PH-level, SH-level or a combination thereof.

In one embodiment, the matching coats correspond to distortion between said one or more neighbouring samples of the current block and one or more corresponding neighbouring sample of each reference block, and wherein the distortion is measured using one or more metrics comprising SATD, SAD, MSE or SSE.

### BRIEF DESCRIPTION OF THE DRAWINGS

FIG. 1A illustrates an exemplary adaptive Inter/Intra video coding system incorporating loop processing.

FIG. 1B illustrates a corresponding decoder for the encoder in FIG. 1A.

FIG. 2 illustrates the neighbouring blocks used for deriving spatial merge candidates for VVC.

FIG. 3 illustrates the possible candidate pairs considered for redundancy check in VVC.

FIG. 4 illustrates an example of temporal candidate derivation, where a scaled motion vector is derived according to POC (Picture Order Count) distances.

FIG. 5 illustrates the position for the temporal candidate selected between candidates C₀ and C₁.

FIG. 6 illustrates the distance offsets from a starting MV in the horizontal and vertical directions according to Merge Mode with MVD (MMVD).

FIG. 7A illustrates an example of the affine motion field of a block described by motion information of two control point (4-parameter).

FIG. 7B illustrates an example of the affine motion field of a block described by motion information of three control point motion vectors (6-parameter).

FIG. 8 illustrates an example of block based affine transform prediction, where the motion vector of each 4×4 luma subblock is derived from the control-point MVs.

FIG. 9 illustrates an example of derivation for inherited affine candidates based on control-point MVs of a neighbouring block.

FIG. 10 illustrates an example of locations of candidates for constructed affine merge mode.

FIG. 11 illustrates an example of affine candidate construction by combining the translational motion information of each control point from spatial neighbours and temporal.

FIG. 12 illustrates an example of the weight value derivation for Combined Inter and Intra Prediction (CIIP) according to the coding modes of the top and left neighbouring blocks.

FIG. 13 illustrates an example of the of 64 partitions used in the VVC standard, where the partitions are grouped according to their angles and dashed lines indicate redundant partitions.

FIG. 14 illustrates an example of uni-prediction MV selection for the geometric partitioning mode.

FIG. 15 illustrates an example of bending weight wo using the geometric partitioning mode.

FIG. 16 illustrates an example of GPM blending process according to a discrete ramp function for the blending area around the boundary.

FIG. 17 illustrates an example of GPM blending process used for GPM blending in ECM 4.0.

FIG. 18 illustrates an example of symmetrical MVD mode.

FIGS. 19A-C illustrate examples of available IPM candidates: the parallel angular mode against the GPM block boundary (Parallel mode, FIG. 19A), the perpendicular angular mode against the GPM block boundary (Perpendicular mode, FIG. 19B), and the Planar mode (FIG. 19C), respectively.

FIG. 19D illustrates an example of GPM with intra and intra prediction, where intra prediction is restricted to reduce the signalling overhead for IPMs and hardware decoder cost.

FIG. 20A illustrates the syntax coding for Spatial GPM (SGPM) before using a simplified method.

FIG. 20B illustrates an example of simplified syntax coding for Spatial GPM (SGPM).

FIG. 21 illustrates an example of the shape of the template used to generate this candidate list.

FIG. 22 illustrates an example of template matching used to refine an initial MV by searching an area around the initial MV.

FIG. 23 illustrates a flowchart of an exemplary video coding system that utilizes template matching to select a MVD among a set of MVD candidates according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

The VVC standard incorporates various new coding tools to further improve the coding efficiency over the HEVC standard. Among various new coding tools, some coding tools relevant to the present invention are reviewed as follows.

### Inter Prediction Overview

According to JVET-T2002 Section 3.4. (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002)), for each inter-predicted CU, motion parameters consist of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU, which are obtained from neighbouring CUs, including spatial and temporal candidates, and additional schedules introduced in VVC. The merge mode can be applied to any inter-predicted CU, not only for skip mode. The alternative to the merge mode is the explicit transmission of motion parameters, where motion vector, corresponding reference picture index for each reference picture list and reference picture list usage flag and other needed information are signalled explicitly per each CU.

Beyond the inter coding features in HEVC, VVC includes a number of new and refined inter prediction coding tools listed as follows:
Extended merge prediction
Merge mode with MVD (MMVD)
Symmetric MVD (SMVD) signalling
Affine motion compensated prediction
Subblock-based temporal motion vector prediction (SbTMVP)
Adaptive motion vector resolution (AMVR)
Motion field storage: 1/16^{th} luma sample MV storage and 8×8 motion field compression
Bi-prediction with CU-level weight (BCW)
Bi-directional optical flow (BDOF)
Decoder side motion vector refinement (DMVR)
Geometric partitioning mode (GPM)
Combined inter and intra prediction (CIIP)

The following description provides the details of those inter prediction methods specified in VVC.

### Extended Merge Prediction

In VVC, the merge candidate list is constructed by including the following five types of candidates in order:
1) Spatial MVP from spatial neighbour CUs
2) Temporal MVP from collocated CUs
3) History-based MVP from an FIFO table
4) Pairwise average MVP
5) Zero MVs.

The size of merge list is signalled in sequence parameter set (SPS) header and the maximum allowed size of merge list is 6. For each CU coded in the merge mode, an index of best merge candidate is encoded using truncated unary binarization (TU). The first bin of the merge index is coded with context and bypass coding is used for remaining bins.

The derivation process of each category of the merge candidates is provided in this session. As done in HEVC, VVC also supports parallel derivation of the merge candidate lists (or called as merging candidate lists) for all CUs within a certain size of area.

### Spatial Candidate Derivation

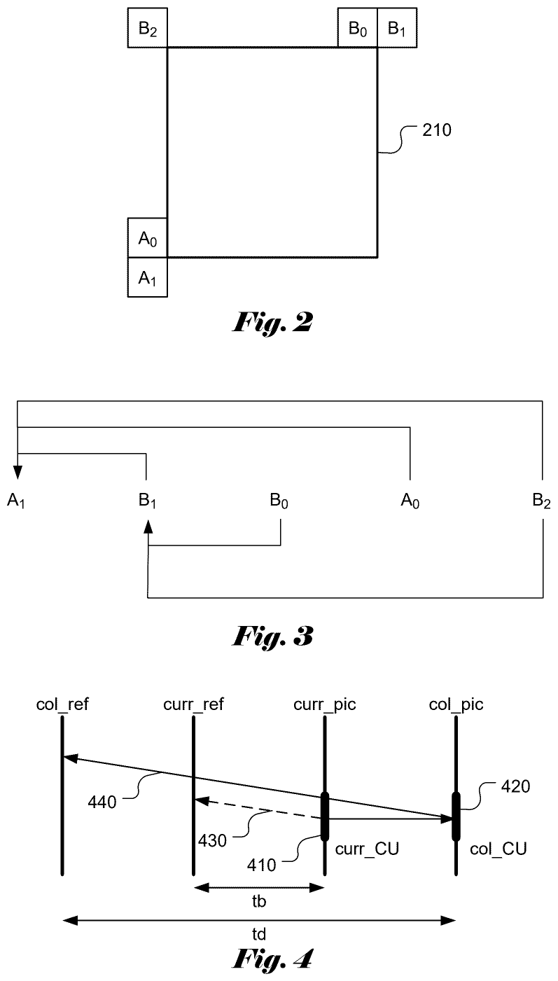

The derivation of spatial merge candidates in VVC is the same as that in HEVC except that the positions of first two merge candidates are swapped. A maximum of four merge candidates (B₀, A₀, B₁ and A₁) for current CU 210 are selected among candidates located in the positions depicted in FIG. 2. The order of derivation is B₀, A₀, B₁. A₁ and B₂. Position B₂ is considered only when one or more neighbouring CU of positions B₀, A₀, B₁, A₁ are not available (e.g. belonging to another slice or tile) or is intra coded. After candidate at position A₁ is added, the addition of the remaining candidates is subject to a redundancy check which ensures that candidates with the same motion information are excluded from the list so that coding efficiency is improved. To reduce computational complexity, not all possible candidate pairs are considered in the mentioned redundancy check. Instead, only the pairs linked with an arrow in FIG. 3 are considered and a candidate is only added to the list if the corresponding candidate used for redundancy check does not have the same motion information.

### Temporal Candidates Derivation

In this step, only one candidate is added to the list. Particularly, in the derivation of this temporal merge candidate for a current CU 410, a scaled motion vector is derived based on the co-located CU 420 belonging to the collocated reference picture as shown in FIG. 4. The reference picture list and the reference index to be used for the derivation of the co-located CU is explicitly signalled in the slice header. The scaled motion vector 430 for the temporal merge candidate is obtained as illustrated by the dotted line in FIG. 4, which is scaled from the motion vector 440 of the co-located CU using the POC (Picture Order Count) distances, tb and td, where tb is defined to be the POC difference between the reference picture of the current picture and the current picture and td is defined to be the POC difference between the reference picture of the co-located picture and the co-located picture. The reference picture index of temporal merge candidate is set equal to zero.

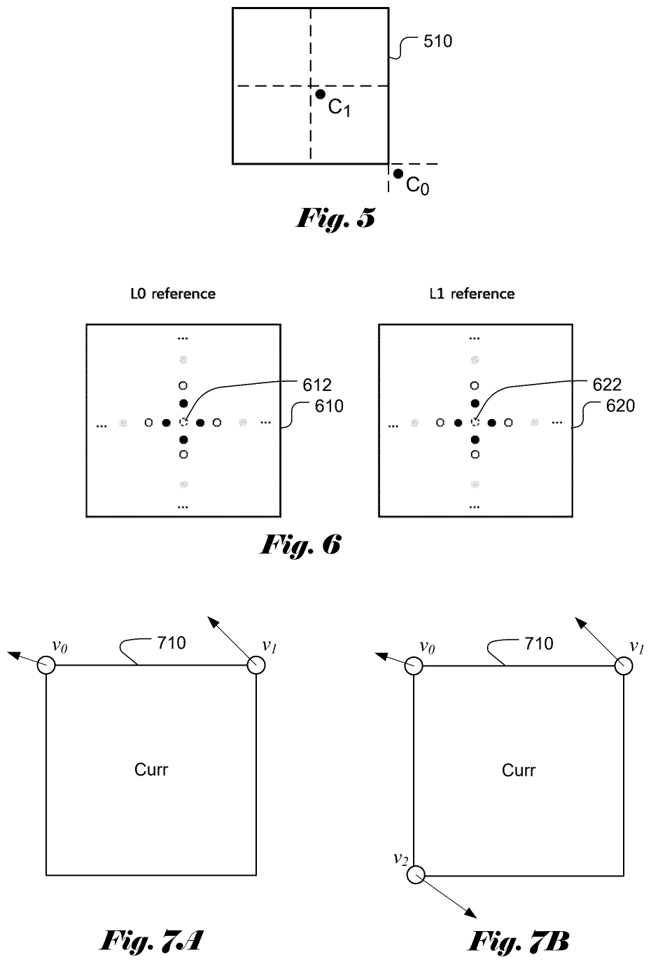

The position for the temporal candidate is selected between candidates C₀ and C₁, as depicted in FIG. 5. If CU at position C₀ is not available, is intra coded, or is outside of the current row of CTUs, position C₁ is used. Otherwise, position C₀ is used in the derivation of the temporal merge candidate. 30

### History-Based Merge Candidates Derivation

The history-based MVP (HMVP) merge candidates are added to the merge list after the spatial MVP and TMVP. In this method, the motion information of a previously coded block is stored in a table and used as MVP for the current CU. The table with multiple HMVP candidates is maintained during the encoding/decoding process. The table is reset (emptied) when a new CTU row is encountered. Whenever there is a non-subblock inter-coded CU, the associated motion information is added to the last entry of the table as a new HMVP candidate.

The HMVP table size S is set to be 6, which indicates up to 5 History-based MVP (HMVP) candidates may be added to the table. When inserting a new motion candidate to the table, a constrained first-in-first-out (FIFO) rule is utilized where redundancy check is firstly applied to find whether there is an identical HMVP in the table. If found, the identical HMVP is removed from the table and all the HMVP candidates afterwards are moved forward, and the identical HMVP is inserted to the last entry of the table.

HMVP candidates could be used in the merge candidate list construction process. The latest several HMVP candidates in the table are checked in order and inserted to the candidate list after the TMVP candidate. Redundancy check is applied on the HMVP candidates to the spatial or temporal merge candidate.

To reduce the number of redundancy, check operations, the following simplifications are introduced:
1. The last two entries in the table are checked for redundancy with respect to A₁ and B₁ spatial candidates, respectively.
2. Once the total number of available merge candidates reaches the maximally allowed merge candidates minus 1, the merge candidate list construction process from HMVP is terminated.

### Pair-Wise Average Merge Candidates Derivation

Pairwise average candidates are generated by averaging predefined pairs of candidates in the existing merge candidate list, using the first two merge candidates. The first merge candidate is defined as p0Cand and the second merge candidate can be defined as p1Cand, respectively. The averaged motion vectors are calculated according to the availability of the motion vector of p0Cand and p1Cand separately for each reference list. If both motion vectors are available in one list, these two motion vectors are averaged even when they point to different reference pictures, and its reference picture is set to the one of p0Cand; if only one motion vector is available, use the one directly; and if no motion vector is available, keep this list invalid. Also, if the half-pel interpolation filter indices of p0Cand and p1Cand are different, it is set to 0.

When the merge list is not full after pair-wise average merge candidates are added, the zero MVPs are inserted in the end until the maximum merge candidate number is encountered.

### Merge Estimation Region

Merge estimation region (MER) allows independent derivation of merge candidate list for the CUs in the same merge estimation region (MER). A candidate block that is within the same MER as the current CU is not included for the generation of the merge candidate list of the current CU. In addition, the updating process for the history-based motion vector predictor candidate list is updated only if (xCb+cbWidth)>>Log2ParMrgLevel is greater than xCb>>Log2ParMrgLevel and (yCb+cbHeight)>>Log2ParMrgLevel is great than (yCb>>Log2ParMrgLevel), and where (xCb, yCb) is the top-left luma sample position of the current CU in the picture and (cbWidth, cbHeight) is the CU size. The MER size is selected at the encoder side and signalled as log2_parallel_merge_level_minus2 in the Sequence Parameter Set (SPS).

Merge Mode with MVD (MMVD)

In addition to the merge mode, where the implicitly derived motion information is directly used for prediction samples generation of the current CU, the merge mode with motion vector differences (MMVD) is introduced in VVC. A MMVD flag is signalled right after sending a regular merge flag to specify whether MMVD mode is used for a CU.

In MMVD, after a merge candidate is selected (referred as a base merge candidate in this disclosure), it is further refined by the signalled MVDs information. The further information includes a merge candidate flag, an index to specify motion magnitude, and an index for indication of motion direction. In MMVD mode, one for the first two candidates in the merge list is selected to be used as MV basis. The MMVD candidate flag is signalled to specify which one is used between the first and second merge candidates.

Distance index specifies motion magnitude information and indicates the pre-defined offset from the starting points (612 and 622) for a L0 reference block 610 and L1 reference block 620. As shown in FIG. 6, an offset is added to either horizontal component or vertical component of the starting MV, where small circles in different styles correspond to different offsets from the centre. The relation of distance index and pre-defined offset is specified in Table 1.

TABLE 1
The relation of distance index and pre-defined offset

| Distance IDX | 0 | 1 | 2 | 3 | 4 | 5 | 6 | 7 |
|---|---|---|---|---|---|---|---|---|
| Offset (in unit of | ¼ | ½ | 1 | 2 | 4 | 8 | 16 | 32 |
| luma sample) | | | | | | | | |

Direction index represents the direction of the MVD relative to the starting point. The direction index can represent the four directions as shown in Table 2. It is noted that the meaning of MVD sign could be variant according to the information of starting MVs. When the starting MVs are an un-prediction MV or bi-prediction MVs with both lists pointing to the same side of the current picture (i.e. POCs of two references both larger than the POC of the current picture, or both smaller than the POC of the current picture), the sign in Table 2 specifies the sign of the MV offset added to the starting MV. When the starting MVs are bi-prediction MVs with the two MVs pointing to the different sides of the current picture (i.e. the POC of one reference larger than the POC of the current picture, and the POC of the other reference smaller than the POC of the current picture), and the difference of POC in list 0 is greater than the one in list 1, the sign in Table 2 specifies the sign of MV offset added to the list 0 MV component of the starting MV and the sign for the list 1 MV has an opposite value. Otherwise, if the difference of POC in list 1 is greater than list 0, the sign in Table 2 specifies the sign of the MV offset added to the list 1 MV component of starting MV and the sign for the list 0 MV has an opposite value.

The MVD is scaled according to the difference of POCs in each direction. If the differences of POCs in both lists are the same, no scaling is needed. Otherwise, if the difference of POC in list 0 is larger than the one in list 1, the MVD for list 1 is scaled, by defining the POC difference of L0 as td and POC difference of L1 as tb, described in FIG. 4. If the POC difference of L1 is greater than L0, the MVD for list 0 is scaled in the same way. If the starting MV is uni-predicted, the MVD is added to the available MV.

TABLE 2
Sign of MV offset specified by direction index

| Direction IDX | 00 | 01 | 10 | 11 |
|---|---|---|---|---|
| x-axis | + | − | N/A | N/A |
| y-axis | N/A | N/A | + | − |

### Affine Motion Compensated Prediction

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. As shown FIGS. 7A-B, the affine motion field of the block 710 is described by motion information of two control point (4-parameter) in FIG. 7A or three control point motion vectors (6-parameter) in FIG. 7B.

For 4-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{1 y} - m {v}_{0 y}}{W} y + m {v}_{0 x} \\ m {v}_{y} = \frac{m {v}_{1 y} - m {v}_{0 y}}{W} x + \frac{m {v}_{1 y} - m {v}_{o x}}{W} y + m {v}_{0 y}\end{matrix} \qquad ( 1 )$$

For 6-parameter affine motion model, motion vector at sample location (x, y) in a block is derived as:

$$\{ \begin{matrix}m {v}_{x} = \frac{m {v}_{1 x} - m {v}_{0 x}}{W} x + \frac{m {v}_{2 x} - m {v}_{0 x}}{H} y + m {v}_{0 x} \\ m {v}_{y} = \frac{m {v}_{1 y} - m {v}_{0 y}}{W} x + \frac{m {v}_{2 y} - m {v}_{0 y}}{H} y + m {v}_{0 y}\end{matrix} \qquad ( 2 )$$

Where (mv₀ₓ, mv_{0y}) is motion vector of the top-left corner control point, (mv₁ₓ, mv_{1y}) is motion vector of the top-right corner control point, and (mv₂ₓ, mv_{2y}) is motion vector of the bottom-left corner control point.

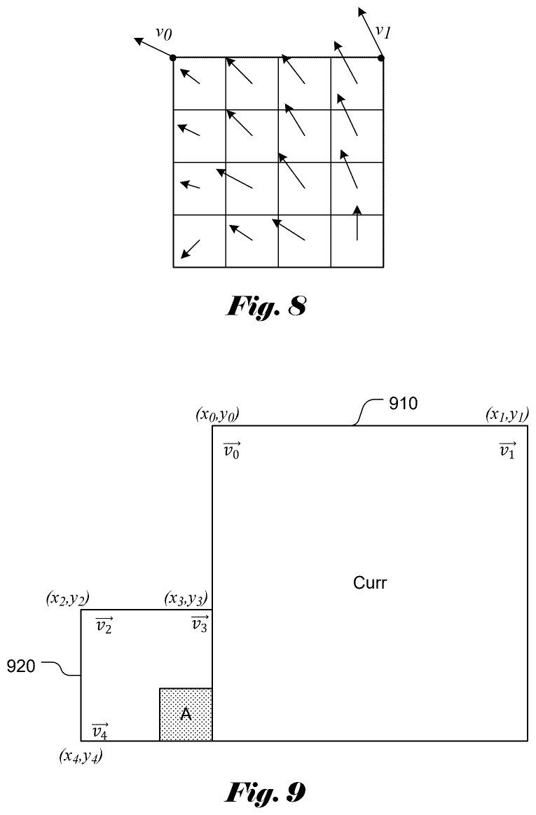

In order to simplify the motion compensation prediction, block based affine transform prediction is applied. To derive motion vector of each 4×4 luma subblock, the motion vector of the centre sample of each subblock, as shown in FIG. 8, is calculated according to above equations, and rounded to 1/16 fraction accuracy. Then, the motion compensation interpolation filters are applied to generate the prediction of each subblock with the derived motion vector. The subblock size of chroma-components is also set to be 4×4. The MV of a 4×4 chroma subblock is calculated as the average of the MVs of the top-left and bottom-right luma subblocks in the collocated 8×8 luma region.

As is for translational-motion inter prediction, there are also two affine motion inter prediction modes: affine merge mode and affine AMVP mode.

### Affine Merge Prediction

AF MERGE mode can be applied for CUs with both width and height larger than or equal to 8. In this mode, the CPMVs (Control Point MVs) of the current CU is generated based on the motion information of the spatial neighbouring CUs. There can be up to five CPMVP (CPMV Prediction) candidates and an index is signalled to indicate the one to be used for the current CU. The following three types of CPVM candidate are used to form the affine merge candidate list:
Inherited affine merge candidates that are extrapolated from the CPMVs of the neighbour CUs
Constructed affine merge candidates CPMVPs that are derived using the translational MVs of the neighbour CUs
Zero MVs

In VVC, there are two inherited affine candidates at most, which are derived from the affine motion model of the neighbouring blocks, one from left neighbouring CUs and one from above neighbouring CUs. The candidate blocks are the same as those shown in FIG. 2. For the left predictor, the scan order is A₀->A₁, and for the above predictor, the scan order is B₀->B₁->B₂. Only the first inherited candidate from each side is selected. No pruning check is performed between two inherited candidates. When a neighbouring affine CU is identified, its control point motion vectors are used to derived the CPMVP candidate in the affine merge list of the current CU. As shown in FIG. 9, if the neighbouring left bottom block A of the current block 910 is coded in affine mode, the motion vectors v₂, v₃ and v₄ of the top left corner, above right corner and left bottom corner of the CU 920 containing block A are attained. When block A is coded with 4-parameter affine model, the two CPMVs of the current CU (i.e., v₀ and v₁) are calculated according to v₂, and v₃. In case that block A is coded with 6-parameter affine model, the three CPMVs of the current CU are calculated according to v₂, v₃ and v₄.

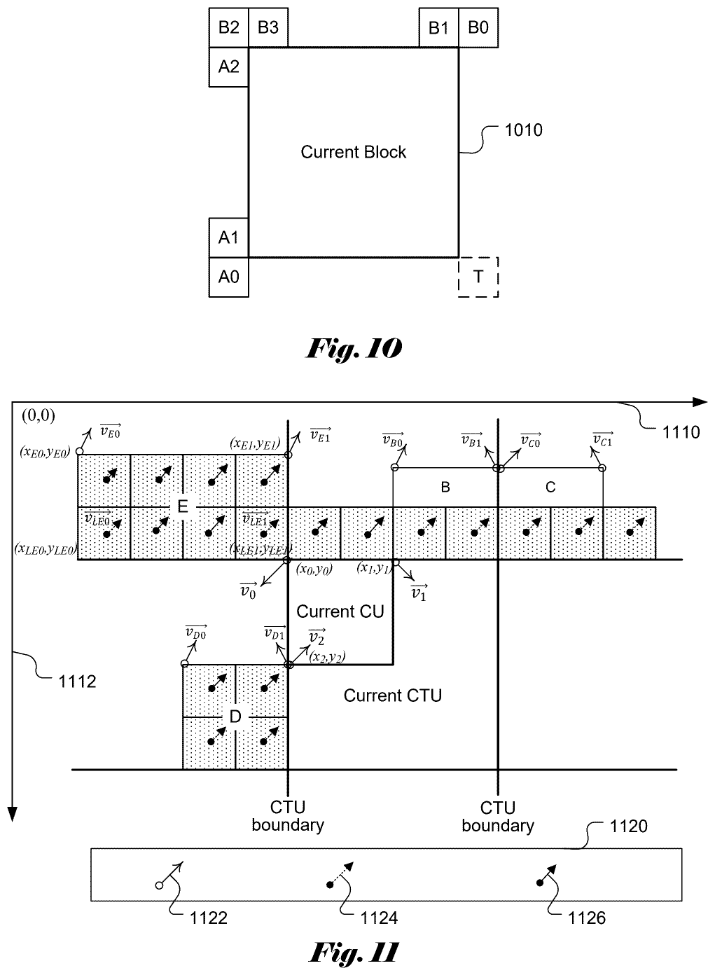

Constructed affine candidate means the candidate is constructed by combining the neighbouring translational motion information of each control point. The motion information for the control points is derived from the specified spatial neighbours and temporal neighbour for a current block 1010 as shown in FIG. 10. CPMVₖ (k=1, 2, 3, 4) represents the k-th control point. For CPMV₁, the B2->B3->A2 blocks are checked and the MV of the first available block is used. For CPMV₂, the B1->B0 blocks are checked and for CPMV3, the A1->A0 blocks are checked. For TMVP is used as CPMV₄ if it's available.

After MVs of four control points are attained, affine merge candidates are constructed based on the motion information. The following combinations of control point MVs are used to construct in order:
{CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, {CPMV₁, CPMV₃}

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded.

After inherited affine merge candidates and constructed affine merge candidate are checked, if the list is still not full, zero MVs are inserted to the end of the list.

### Affine AMVP Prediction

Affine AMVP mode can be applied for CUs with both width and height larger than or equal to 16. An affine flag in the CU level is signalled in the bitstream to indicate whether affine AMVP mode is used and then another flag is signalled to indicate whether 4-parameter affine or 6-parameter affine is used. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighbouring CUs
Zero MVs

The checking order of inherited affine AMVP candidates is the same as the checking order of inherited affine merge candidates. The only difference is that, for AVMP candidate, only the affine CU that has the same reference picture as current block is considered. No pruning process is applied when inserting an inherited affine motion predictor into the candidate list.

Constructed AMVP candidate is derived from the specified spatial neighbours shown in FIG. 10. The same checking order is used as that in the affine merge candidate construction. In addition, the reference picture index of the neighbouring block is also checked. In the checking order, the first block that is inter coded and has the same reference picture as in current CUs is used. When the current CU is coded with the 4-parameter affine mode, and mv₀^{□} and mv₁^{□} are both available, they are added as one candidate in the affine AMVP list. When the current CU is coded with 6-parameter affine mode, and all three CPMVs are available, they are added as one candidate in the affine AMVP list. Otherwise, the constructed AMVP candidate is set as unavailable.

If the number of affine AMVP list candidates is still less than 2 after valid inherited affine AMVP candidates and constructed AMVP candidate are inserted, mv₀^{□}, mv₁^{□} and mv₂^{□} will be added as the translational MVs in order to predict all control point MVs of the current CU, when available. Finally, zero MVs are used to fill the affine AMVP list if it is still not full.

### Affine Motion Information Storage

In VVC, the CPMVs of affine CUs are stored in a separate buffer. The stored CPMVs are only used to generate the inherited CPMVPs in the affine merge mode and affine AMVP mode for the lately coded CUs. The subblock MVs derived from CPMVs are used for motion compensation, MV derivation of merge/AMVP list of translational MVs and de-blocking.

To avoid the picture line buffer for the additional CPMVs, affine motion data inheritance from the CUs of the above CTU is treated differently for the inheritance from the normal neighbouring CUs. If the candidate CU for affine motion data inheritance is in the above CTU line, the bottom-left and bottom-right subblock MVs in the line buffer instead of the CPMVs are used for the affine MVP derivation. In this way, the CPMVs are only stored in a local buffer. If the candidate CU is 6-parameter affine coded, the affine model is degraded to 4-parameter model. As shown in FIG. 11, along the top CTU boundary, the bottom-left and bottom right subblock motion vectors of a CU are used for affine inheritance of the CUs in bottom CTUs. In FIG. 11, line 1110 and line 1112 indicate the x and y coordinates of the picture with the origin (0,0) at the upper left corner. Legend 1120 shows the meaning of various motion vectors, where arrow 1122 represents the CPMVs for affine inheritance in the local buff, arrow 1124 represents sub-block vectors for MC/merge/skip/AMVP/deblocking/TMVPs in the local buffer and for affine inheritance in the line buffer, and arrow 1126 represents sub-block vectors for MC/merge/skip/AMVP/deblocking/TMVPs.

### Adaptive Motion Vector Resolution (AMVR)

In HEVC, motion vector differences (MVDs) (between the motion vector and predicted motion vector of a CU) are signalled in units of quarter-luma-sample when use_integer_mv_flag is equal to 0 in the slice header. In VVC, a CU-level adaptive motion vector resolution (AMVR) scheme is introduced. AMVR allows MVD of the CU to be coded in different precisions. Dependent on the mode (normal AMVP mode or affine AVMP mode) for the current CU, the MVDs of the current CU can be adaptively selected as follows:
Normal AMVP mode: quarter-luma-sample, half-luma-sample, integer-luma-sample or four-luma-sample.
Affine AMVP mode: quarter-luma-sample, integer-luma-sample or 1/16 luma-sample.

The CU-level MVD resolution indication is conditionally signalled if the current CU has at least one non-zero MVD component. If all MVD components (that is, both horizontal and vertical MVDs for reference list L0 and reference list L1) are zero, quarter-luma-sample MVD resolution is inferred.

For a CU that has at least one non-zero MVD component, a first flag is signalled to indicate whether quarter-luma-sample MVD precision is used for the CU. If the first flag is 0, no further signalling is needed and quarter-luma-sample MVD precision is used for the current CU. Otherwise, a second flag is signalled to indicate half-luma-sample or other MVD precisions (integer or four-luma sample) is used for a normal AMVP CU. In the case of half-luma-sample, a 6-tap interpolation filter instead of the default 8-tap interpolation filter is used for the half-luma sample position. Otherwise, a third flag is signalled to indicate whether integer-luma-sample or four-luma-sample MVD precision is used for the normal AMVP CU. In the case of affine AMVP CU, the second flag is used to indicate whether integer-luma-sample or 1/16 luma-sample MVD precision is used. In order to ensure the reconstructed MV has the intended precision (quarter-luma-sample, half-luma-sample, integer-luma-sample or four-luma-sample), the motion vector predictors for the CU will be rounded to the same precision as that of the MVD before being added together with the MVD. The motion vector predictors are rounded toward zero (that is, a negative motion vector predictor is rounded toward positive infinity and a positive motion vector predictor is rounded toward negative infinity).

The encoder determines the motion vector resolution for the current CU using RD check. To avoid always performing the CU-level RD check four times for each MVD resolution, the RD check of MVD precisions other than quarter-luma-sample is only invoked conditionally in VTM11. For the normal AVMP mode, the RD cost of quarter-luma-sample MVD precision and integer-luma sample MV precision is computed first. Then, the RD cost of integer-luma-sample MVD precision is compared to that of quarter-luma-sample MVD precision to decide whether it is necessary to further check the RD cost of four-luma-sample MVD precision. When the RD cost for the quarter-luma-sample MVD precision is much smaller than that of the integer-luma-sample MVD precision, the RD check of four-luma-sample MVD precision is skipped. Then, the check of half-luma-sample MVD precision is skipped if the RD cost of integer-luma-sample MVD precision is significantly larger than the best RD cost of previously tested MVD precisions. For the affine AMVP mode, if the affine inter mode is not selected after checking rate-distortion costs of affine merge/skip mode, merge/skip mode, quarter-luma-sample MVD precision normal AMVP mode and quarter-luma-sample MVD precision affine AMVP mode, then 1/16 luma-sample MV precision and 1-pel MV precision affine inter modes are not checked. Furthermore, affine parameters obtained in quarter-luma-sample MV precision affine inter mode are used as starting search point in 1/16 luma-sample and quarter-luma-sample MV precision affine inter modes.

Bi-Prediction with CU-Level Weight (BCW)

In HEVC, the bi-prediction signal, P_{bi-pred} is generated by averaging two prediction signals, P₀ and P₁ obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) >> 3 \qquad ( 3 )$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used. At the encoder, fast search algorithms are applied to find the weight index without significantly increasing the encoder complexity. These algorithms are summarized as follows. The details are disclosed in the VTM software and document JVET-L0646 (Yu-Chi Su, et. al., “CE4-related: Generalized bi-prediction improvements combined from JVET-L0197 and JVET-L0296”, Joint Video Experts Team (JVET) of ITU-T SG 16 WP 3 and ISO/IEC JTC 1/SC 29, 12th Meeting: Macao, CN, 3-12 Oct. 2018, Document: JVET-L0646).
When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and weight w is inferred to be 4 (i.e. equal weight is applied). For a merge CU, the weight index is inferred from neighbouring blocks based on the merge candidate index. This can be applied to both the normal merge mode and inherited affine merge mode. For the constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, (i.e., w=4 for equal weight). Equal weight implies the default value for the BCW index.

### Combined Inter and Intra Prediction (CHIP)

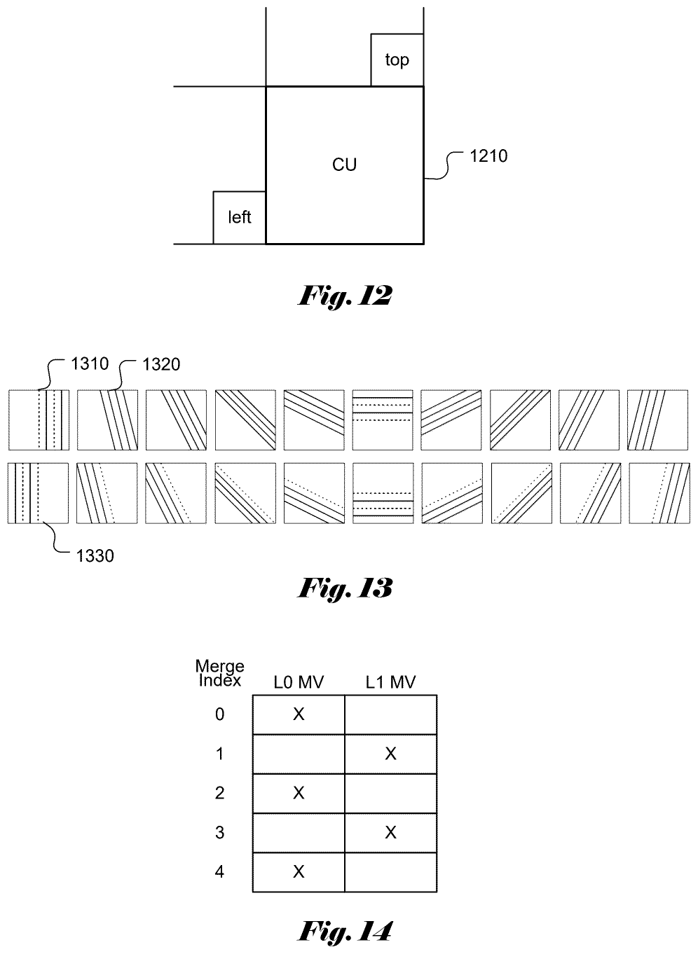

In VVC, when a CU is coded in merge mode, if the CU contains at least 64 luma samples (that is, CU width times CU height is equal to or larger than 64), and if both CU width and CU height are less than 128 luma samples, an additional flag is signalled to indicate if the combined inter/intra prediction (CIIP) mode is applied to the current CU. As its name indicates, the CIIP prediction combines an inter prediction signal with an intra prediction signal. The inter prediction signal in the CIIP mode Pᵢₙₜₑᵣ is derived using the same inter prediction process applied to regular merge mode; and the intra prediction signal Pᵢₙₜᵣₐ is derived following the regular intra prediction process with the planar mode. Then, the intra and inter prediction signals are combined using weighted averaging, where the weight value wt is calculated depending on the coding modes of the top and left neighbouring blocks (as shown in FIG. 12) of current CU 1210 as follows:
If the top neighbour is available and intra coded, then set isIntraTop to 1, otherwise set isIntraTop to 0;
If the left neighbour is available and intra coded, then set isIntraLeft to 1, otherwise set isIntraLeft to 0;
If (isIntraLeft+isIntraTop) is equal to 2, then wt is set to 3;
Otherwise, if (isIntraLeft+isIntraTop) is equal to 1, then wt is set to 2;
Otherwise, set wt to 1.

The CIIP prediction is formed as follows:

$${P}_{CIIP} = ( ( 4 - wt ) * {P}_{inter} + wt * {P}_{intra} + 2 ) >> 2 \qquad ( 4 )$$

### Geometric Partitioning Mode (GPM)

In VVC, a Geometric Partitioning Mode (GPM) is supported for inter prediction as described in JVET-W2002 (Adrian Browne, et al., Algorithm description for Versatile Video Coding and Test Model 14 (VTM 14), ITU-T/ISO/IEC Joint Video Exploration Team (JVET), 23rd Meeting, by teleconference, 7-16 Jul. 2021, document: document JVET-M2002). The geometric partitioning mode is signalled using a CU-level flag as one kind of merge mode, with other merge modes including the regular merge mode, the MMVD mode, the CIIP mode and the subblock merge mode. A total of 64 partitions are supported by geometric partitioning mode for each possible CU size, w×h=2^{m}×2ⁿ with m, n∈{3 . . . 6} excluding 8×64 and 64×8. The GPM mode can be applied to skip or merge CUs having a size within the above limit and having at least two regular merge modes.

When this mode is used, a CU is split into two parts by a geometrically located straight line in certain angles. In VVC, there are a total of 20 angles and 4 offset distances used for GPM, which has been reduced from 24 angles in an earlier draft. The location of the splitting line is mathematically derived from the angle and offset parameters of a specific partition. In VVC, there are a total of 64 partitions as shown in FIG. 13, where the partitions are grouped according to their angles and dashed lines indicate redundant partitions. Each part of a geometric partition in the CU is inter-predicted using its own motion; only uni-prediction is allowed for each partition, that is, each part has one motion vector and one reference index. In FIG. 13, each line corresponds to the boundary of one partition. The partitions are grouped according to its angle. For example, partition group 1310 consists of three vertical GPM partitions (i.e., 90°). Partition group 1320 consists of four slant GPM partitions with a small angle from the vertical direction. Also, partition group 1330 consists of three vertical GPM partitions (i.e., 270°) similar to those of group 1310, but with an opposite direction. The uni-prediction motion constraint is applied to ensure that only two motion compensated prediction are needed for each CU, same as the conventional bi-prediction. The uni-prediction motion for each partition is derived using the process described later.

If geometric partitioning mode is used for the current CU, then a geometric partition index indicating the selected partition mode of the geometric partition (angle and offset), and two merge indices (one for each partition) are further signalled. The number of maximum GPM candidate size is signalled explicitly in SPS (Sequence Parameter Set) and specifies syntax binarization for GPM merge indices. After predicting each of part of the geometric partition, the sample values along the geometric partition edge are adjusted using a blending processing with adaptive weights using the process described later. This is the prediction signal for the whole CU, and transform and quantization process will be applied to the whole CU as in other prediction modes. Finally, the motion field of a CU predicted using the geometric partition modes is stored using the process described later.

### Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate (X=0 or 1, i.e., LX=L0 or L1), with X equal to the parity of n, is used as the n-th uni-prediction motion vector for geometric partitioning mode. These motion vectors are marked with “x” in FIG. 14. In case a corresponding LX motion vector of the n-the extended merge candidate does not exist, the L(1−X) motion vector of the same candidate is used instead as the uni-prediction motion vector for geometric partitioning mode.

### Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The two integer blending matrices (W₀ and W₁) are utilized for the GPM blending process. The weights in the GPM blending matrices contain the value range of [0, 8] and are derived based on the displacement from a sample position to the GPM partition boundary 1540 as shown in FIG. 15.

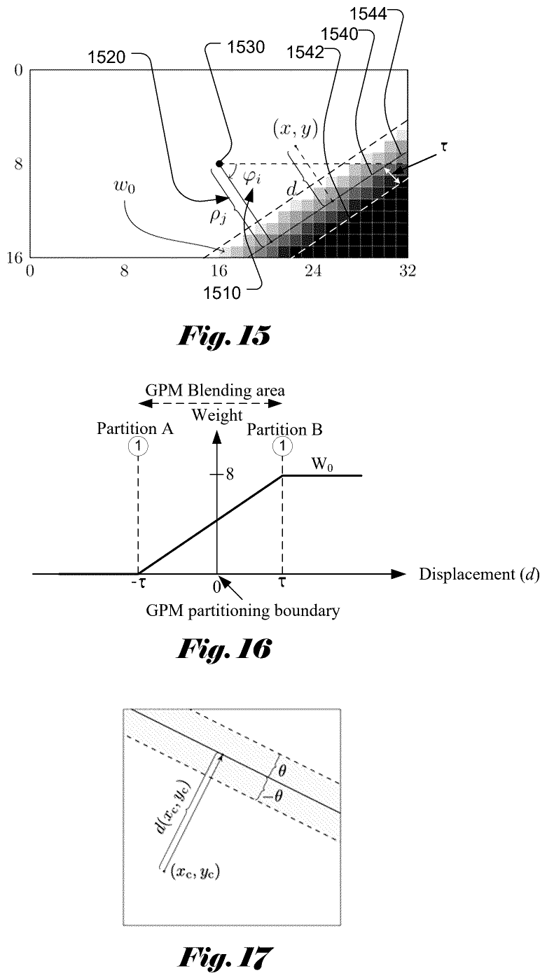

Specifically, the weights are given by a discrete ramp function with the displacement and two thresholds as shown in FIG. 16, where the two end points (i.e., −τ and τ) of the ramp correspond to lines 1542 and 1544 in FIG. 15.

Here, the threshold t defines the width of the GPM blending area and is selected as the fixed value in VVC. In other words, as JVET-Z0137 (Han Gao, et. al., “Non-EE2: Adaptive Blending for GPM”, Joint Video Experts Team (JVET) of ITU-T SG 16 WP 3 and ISO/IEC JTC 1/SC 29, 26th Meeting, by teleconference, 20-29 Apr. 2022, JVET-Z0137), the blending strength or blending area width θ is fixed for all different contents.

The weighing values in the blending mask can be given by a ramp function

$${ω}_{{x}_{c} , {y}_{c}} = \{ \begin{matrix}0 & d ( {x}_{c} , {y}_{c} ) \leq - θ \\ \frac{8}{2 θ} ( d ( {x}_{c} , {y}_{c} ) + θ ) & - θ < d ( {x}_{c} , {y}_{c} ) < θ \\ 8 & d ( {x}_{c} , {y}_{c} ) \geq θ ,\end{matrix} \qquad ( 5 )$$

With a fixed θ=2 pel in the current ECM (VVC) design, this ramp function can be quantized as:

$${ω}_{m , n} = Clip 3 ( 0 , 8 , ( d ( m , n ) + 32 + 4 ) >> 3 ) \qquad ( 6 )$$

The distance for a position (x, y) to the partition edge are derived as:

$$d ( x , y ) = ( 2 x + 1 - w ) cos ( {φ}_{i} ) + ( 2 y + 1 - h ) sin ( {φ}_{i} ) - {ρ}_{j} \qquad ( 7 )$$

$${ρ}_{j} = {ρ}_{x , j} cos ( {φ}_{i} ) + {ρ}_{y , j} sin ( {φ}_{i} ) \qquad ( 8 )$$

$${ρ}_{x , j} = \{ \begin{matrix}0 & i \%16 = 8 or ( i \%16 \neq 0 and h \geq w ) \\ \pm ( j \times w ) >> 2 & otherwise\end{matrix} \qquad ( 9 )$$

$${ρ}_{y , j} = \{ \begin{matrix}\pm ( j \times h ) >> 2 & i \%16 = 8 or ( i \%16 \neq 0 and h \geq w ) \\ 0 & otherwise\end{matrix} \qquad ( 10 )$$

where i, j are the indices for angle and offset of a geometric partition, which depend on the signaled geometric partition index. The sign of ρ_{x,j} and ρ_{y,j} depend on angle index i.

FIG. 17 illustrates an example of GPM blending according to ECM 4.0 (Muhammed Coban, et. al., “Algorithm description of Enhanced Compression Model 4 (ECM 4)”, Joint Video Experts Team (JVET) of ITU-T SG 16 WP 3 and ISO/IEC JTC 1/SC 29, 26th Meeting, by teleconference, 20-29 Apr. 2022, JVET-Y2025). In FIG. 17, the size of the blending region on each side of the partition boundary is indicated by θ. The weights for each part of a geometric partition are derived as following:

$$wIdxL ( x , y ) = partIdx ? 32 + d ( x , y ) : 32 - d ( x , y ) \qquad ( 11 )$$

$${w}_{0} ( x , y ) = \frac{Clip 3 ( 0 , 8 , ( wIdxL ( x , y ) + 4 ) >> 3 )}{8} \qquad ( 12 )$$

$${w}_{1} ( x , y ) = 1 - {w}_{0} ( x , y ) \qquad ( 13 )$$

The partIdx depends on the angle index i. One example of weigh wo is illustrated in FIG. 15, where the angle φᵢ 1510 and offset ρᵢ 1520 are indicated for GPM index i and point 1530 corresponds to the center of the block. Line 1540 corresponds to the GPM partitioning boundary

### Motion Field Storage for Geometric Partitioning Mode

Mv1 from the first part of the geometric partition, Mv2 from the second part of the geometric partition and a combined MV of Mv1 and Mv2 are stored in the motion filed of a geometric partitioning mode coded CU.

The stored motion vector type for each individual position in the motion filed are determined as:

$$sType = abs ( motionIdx ) < 32 ? 2 : ( motionIdx \leq 0 ? ( 1 - partIdx ) : partIdx ) \qquad ( 14 )$$

where motionIdx is equal to d4x+2, 4y+2), which is recalculated from equation (7). The partIdx depends on the angle index i.

If sType is equal to 0 or 1, Mv0 or Mv1 are stored in the corresponding motion field, otherwise if sType is equal to 2, a combined MV from Mv0 and Mv2 are stored. The combined Mv are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### Symmetric MVD (SMVD) Coding

In VVC, besides the normal unidirectional prediction and bi-directional prediction mode MVD signalling, symmetric MVD mode for bi-prediction MVD signalling is applied. In the symmetric MVD mode, motion information including reference picture indices of both list-0 and list-1 and MVD of list-1 are not signalled but derived.

The decoding process of the symmetric MVD mode is as follows:
1. At slice level, variables BiDirPredFlag, RefIdxSymL0 and RefIdxSymL1 are derived as follows:
   If mvd_l1_zero_flag is 1, BiDirPredFlag is set equal to 0.
   Otherwise, if the nearest reference picture in list-0 and the nearest reference picture in list-1 form a forward and backward pair of reference pictures or a backward and forward pair of reference pictures, BiDirPredFlag is set to 1, and both list-0 and list-1 reference pictures are short-term reference pictures. Otherwise BiDirPredFlag is set to 0.
2. At CU level, a symmetrical mode flag indicating whether symmetrical mode is used or not is explicitly signaled if the CU is bi-prediction coded and BiDirPredFlag is equal to 1.

When the symmetrical mode flag is true, only mvp_0_flag, mvp_l1_flag and MVD0 are explicitly signaled. The reference indices for list-0 and list-1 are set equal to the pair of reference pictures, respectively. MVD1 is set equal to (−MVD0). The final motion vectors are shown in below formula.

$$\{ \begin{matrix}( {mvx}_{0} , {mvy}_{0} ) = ( {mvpx}_{0} + {mvdx}_{0} , {mvpy}_{0} + {mvdy}_{0} ) & ( 15 ) \\ ( {mvx}_{1} , {mvy}_{1} ) = ( {mvpx}_{1} - {mvdx}_{0} , {mvpy}_{1} - {mvdy}_{0} ) & ( 16 )\end{matrix}$$

In the encoder, symmetric MVD motion estimation starts with initial MV evaluation. A set of initial MV candidates comprising of the MV obtained from uni-prediction search, the MV obtained from bi-prediction search and the MVs from the AMVP list. The one with the lowest rate-distortion cost is chosen to be the initial MV for the symmetric MVD motion search.

FIG. 18 illustrates an example of symmetric MVD mode, where frames 1800, 1810 and 1820 correspond to the current picture, list-0 reference picture and list-1 reference picture respectively. Block 1802 corresponds to the current block, blocks 1814 and 1822 correspond to the reference blocks according to the initial MV evaluation. The final MVs are determined by searching around the initial MVs and the lowest cost positions are selected as the final reference blocks (1812 and 1819). The MVDs are labels as 1818 and 1826.

### Multi-Hypothesis Prediction (MHP)

In the multi-hypothesis inter prediction mode (JVET-M0425), one or more additional motion-compensated prediction signals are signalled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

$${p}_{3} = ( 1 - α ) {p}_{b i} + α {h}_{3} \qquad ( 17 )$$

The weighting factor α is specified by the new syntax element add_hyp_weight_idx, according to the following mapping (Table 3):

TABLE 3
Mapping α to add_hyp_weight_idx

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1} \qquad ( 18 )$$

The resulting overall prediction signal is obtained as the last pₙ (i.e., the pₙ having the largest index n). For example, up to two additional prediction signals can be used (i.e., n is limited to 2).

The motion parameters of each additional prediction hypothesis can be signalled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode. Details of MHP for VVC can be found in JVET-W2025 (Muhammed Coban, et. al., “Algorithm description of Enhanced Compression Model 2 (ECM 2)”, Joint Video Experts Team (JVET) of ITU-T SG 16 WP 3 and ISO/IEC JTC 1/SC 29, 23rd Meeting, by teleconference, 7-16 Jul. 2021, Document: JVET-W2025).

### GPM Extension

Several variations of GPM mode (JVET-W0097 (Zhipin Deng, et. al., “AEE2-related: Combination of EE2-3.3, EE2-3.4 and EE2-3.5”, Joint Video Experts Team (JVET) of ITU-T SG 16 WP 3 and ISO/IEC JTC 1/SC 29, 23rd Meeting, by teleconference, 7-16 Jul. 2021, Document: JVET-W0097) and JVET-Y0065 (Yoshitaka Kidani, et. al., “EE2-3.1: GPM with inter and intra prediction (JVET-X0166)”, Joint Video Experts Team (JVET) of ITU-T SG 16 WP 3 and ISO/IEC JTC 1/SC 29, 25th Meeting, by teleconference, 12-21 Jan. 2022, Document: JVET-Y0065)) have been proposed to improve the coding efficiency of the GPM mode in the VVC. The methods were included in the exploration experiment (EE2) for further evaluations, the main technical aspects of which are described as follows:

EE2-3.3 on GPM with MMVD (GPM-MMVD): 1) additional MVDs are added to the existing GPM merge candidates; 2) the MVDs are signalled in the same manner as the MMVD in the VVC, i.e., one distance index plus one direction index; 3) two flags are signalled to separately control whether the MMVD is applied to each GPM partition or not.

EE2-3.4-3.5 on GPM with template matching (GPM-TM): 1) template matching is extended to the GPM mode by refining the GPM MVs based on the left and above neighbouring samples of the current CU; 2) the template samples are selected dependent on the GPM split direction; 3) one single flag is signalled to jointly control whether the template matching is applied to the MVs of two GPM partitions or not.

JVET-W0097 proposes a combination of EE2-3.3, EE2-3.4 and EE2-3.5 to further improve the coding efficiency of the GPM mode. Specifically, in the proposed combination, the existing designs in EE2-3.3, EE2-3.4 and EE2-3.5 are kept unchanged while the following modifications are further applied for the harmonization of the two coding tools:
1) The GPM-MMVD and GPM-TM are exclusively enabled to one GPM CU. This is done by firstly signalling the GPM-MMVD syntax. When both two GPM-MMVD control flags are equal to false (i.e., the GPM-MMVD are disabled for two GPM partitions), the GPM-TM flag is signalled to indicate whether the template matching is applied to the two GPM partitions. Otherwise (at least one GPM-MMVD flag is equal to true), the value of the GPM-TM flag is inferred to be false.
2) The GPM merge candidate list generation methods in EE2-3.3 and EE2-3.4-3.5 are directly combined in a manner that the MV pruning scheme in EE2-3.4-3.5 (where the MV pruning threshold is adapted based on the current CU size) is applied to replace the default MV pruning scheme applied in EE2-3.3; additionally, as in EE2-3.4-3.5, multiple zero MVs are added until the GPM candidate list is fully filled.

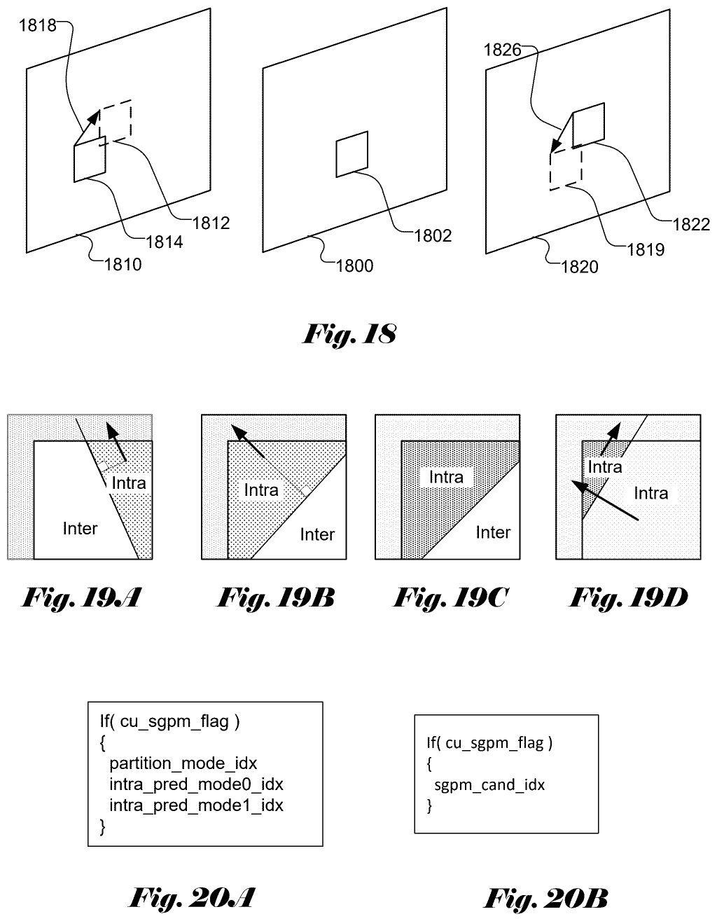

In JVET-Y0065, in GPM with inter and intra prediction (or named GPM intra), the final prediction samples are generated by weighting inter predicted samples and intra predicted samples for each GPM-separated region. The inter predicted samples are derived by the same scheme as the GPM in the current ECM whereas the intra predicted samples are derived by an intra prediction mode (IPM) candidate list and an index signalled from the encoder. The IPM candidate list size is pre-defined as 3. The available IPM candidates are the parallel angular mode against the GPM block boundary (Parallel mode), the perpendicular angular mode against the GPM block boundary (Perpendicular mode), and the Planar mode as shown FIGS. 19A-C, respectively. Furthermore, GPM with intra and intra prediction as shown FIG. 19D is restricted in the proposed method to reduce the signalling overhead for IPMs and avoid an increase in the size of the intra prediction circuit on the hardware decoder. In addition, a direct motion vector and IPM storage on the GPM-blending area is introduced to further improve the coding performance.

### Spatial GPM

Similar to inter GPM, Spatial GPM (SGPM) consists of one partition mode and two associated intra prediction modes. If these modes are directly signalled in the bit-stream, as shown in FIG. 20A, it would yield significant overhead bits. To express the necessary partition and prediction information more efficiently in the bit-stream, a candidate list is employed and only the candidate index is signalled in the bit-stream. Each candidate in the list can derive a combination of one partition mode and two intra prediction modes, as shown in FIG. 20B.

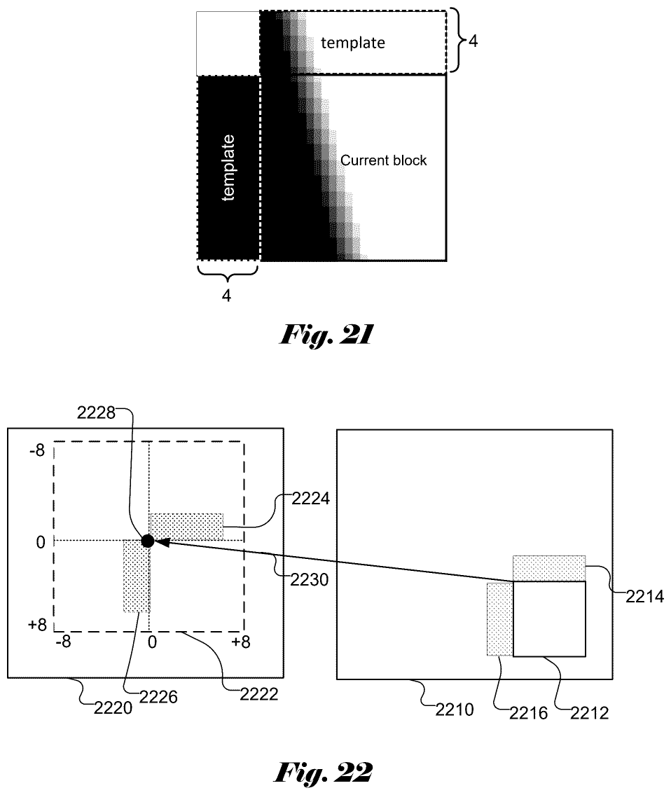

A template is used to generate this candidate list. The shape of the template is shown in FIG. 21. For each possible combination of one partition mode and two intra prediction modes, a prediction is generated for the template with the partitioning weight extended to the template, as shown in FIG. 21. These combinations are ranked in ascending order of their SATD between the prediction and reconstruction of the template. The length of the candidate list is set equal to 16, and these candidates are regarded as the most probable SGPM combinations of the current block. Both encoder and decoder construct the same candidate list based upon the template.

To reduce the complexity in building the candidate list, both the number of possible partition modes and the number of possible intra prediction modes are pruned. In the following test, 26 out of 64 partition modes are used, and only the MPMs out of 67 intra prediction modes are used.

### Template Matching for MV Refinement

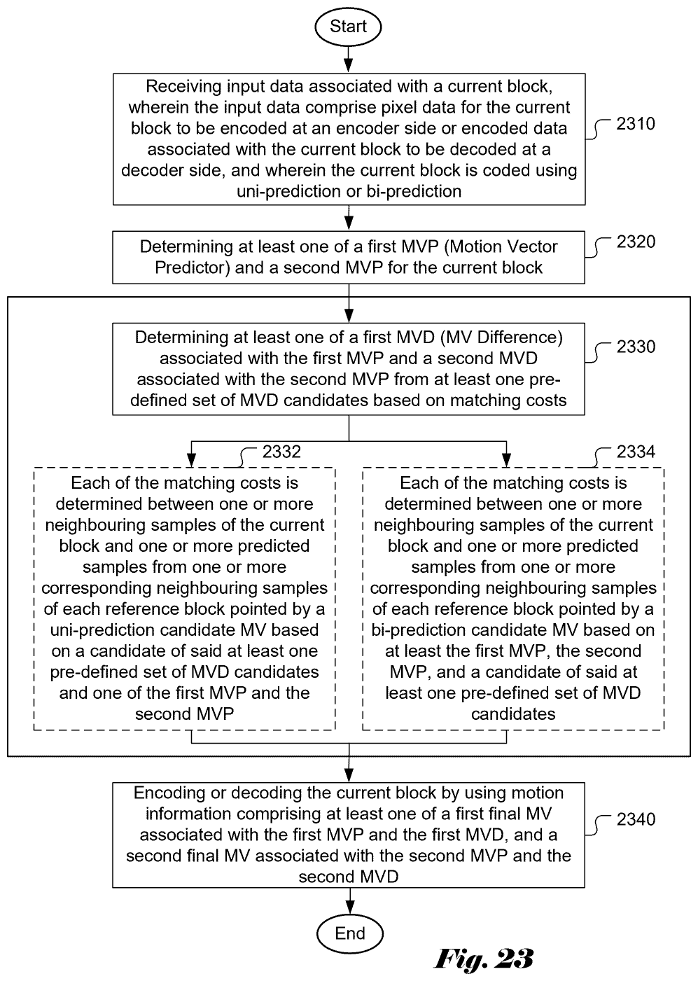

Template matching (TM) is a decoder-side MV derivation method to refine the motion information of the current CU by finding the closest match between a template (i.e., top 2214 and/or left 2216 neighbouring blocks of the current CU 2212) in the current picture 2210 and a block (i.e., same size to the template, block 2224 and 2226) in a reference picture 2220 as shown in FIG. 22. In FIG. 22, a better MV is searched around the initial motion 2230 of the current CU 2212 of the current picture 2210 within a [−8, +8]-pel search range 2222 around location 2228 in the reference picture 2220 as pointed by the initial MV 2230. The template matching method in JVET-J0021 is used with the following modifications: search step size is determined based on AMVR mode and TM can be cascaded with bilateral matching process in merge modes.

In the AMVP mode, an MVP candidate is determined based on the template matching error to select the one which reaches the minimum difference between the current block template and the reference block template. TM is then performed only for this particular MVP candidate for MV refinement. TM refines this MVP candidate by using iterative diamond search starting from full-pel MVD precision (or 4-pel for 4-pel AMVR mode) within a [−8, +8]-pel search range. The AMVP candidate may be further refined by using cross search with full-pel MVD precision (or 4-pel for 4-pel AMVR mode), followed sequentially by half-pel and quarter-pel ones depending on AMVR mode as specified in Table 4. This search process ensures that the MVP candidate still keeps the same MV precision as indicated by the AMVR mode after the TM process. In the search process, if the difference between the previous minimum cost and the current minimum cost in the iteration is less than a threshold that is equal to the area of the block, the search process terminates.

TABLE 4
Search patterns of AMVR and merge mode with AMVR.

| | AMVR mode | | | | | |
|---|---|---|---|---|---|---|
| | | Full- | Half- | Quarter- | Merge mode | |
| Search pattern | 4-pel | pel | pel | pel | AltIF = 0 | AltIF = 1 |
| 4-pel diamond | v | | | | | |
| 4-pel cross | v | | | | | |
| Full-pel diamond | | v | v | v | v | v |
| Full-pel cross | | v | v | v | v | v |
| Half-pel cross | | | v | v | v | v |
| Quarter-pel cross | | | | v | v | |
| ⅛-pel cross | | | | | v | |

In the merge mode, similar search method is applied to the merge candidate indicated by the merge index. As shown in Table 4, TM may be performed all the way down to ⅛-pel MVD precision or skipping those beyond half-pel MVD precision, depending on whether the alternative interpolation filter (used for AMVR being a half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check.

In VVC, some inter tools are proposed as a short-cut mode to reduce the syntax overhead of a motion candidate. Originally, for each direction (list 0 or list 1), the following syntax is required for a bi-prediction motion candidate to get their motion information, as shown in Table 5 for VVC standard:
Reference index
Mvd
Mvp index

TABLE 5
Syntax Table for Motion Information

| | |
|---|---|
| if( inter_pred_idc[ x0 ][ y0 ] != PRED_L1 ) { | |
| if( NumRefIdxActive[ 0 ] > 1 && !sym_mvd_flag[ x0 ][ y0 ] ) | |
| ref_idx_l0[ x0 ][ y0 ] | ae(v) |
| mvd_coding( x0, y0, 0, 0 ) | |
| if( MotionModelIdc[ x0 ][ y0 ] > 0 ) | |
| mvd_coding( x0, y0, 0, 1 ) | |
| if(MotionModelIdc[ x0 ][ y0 ] > 1 ) | |
| mvd_coding( x0, y0, 0, 2 ) | |
| mvp_l0_flag[ x0 ][ y0 ] | ae(v) |
| } else { | |
| MvdL0[ x0 ][ y0 ][ 0 ] = 0 | |
| MvdL0[ x0 ][ y0 ][ 1 ] = 0 | |
| } | |
| if( inter_pred_idc[ x0 ][ y0 ] != PRED_L0 ) { | |
| if( NumRefIdxActive[ 1 ] > 1 && !sym_mvd_flag[ x0 ][ y0 ] ) | |
| ref_idx_l1[ x0 ][ y0 ] | ae(v) |
| if( ph_mvd_l1_zero_flag && inter_pred_idc[ x0 ][ y0 ] = = | |
| PRED_BI ) { | |
| MvdL1[ x0 ][ y0 ][ 0 ] = 0 | |
| MvdL1[ x0 ][ y0 ][ 1 ] = 0 | |
| MvdCpL1[ x0 ][ y0 ][ 0 ][ 0 ] = 0 | |
| MvdCpL1[ x0 ][ y0 ][ 0 ][ 1 ] = 0 | |
| MvdCpL1[ x0 ][ y0 ][ 1 ][ 0 ] = 0 | |
| MvdCpL1[ x0 ][ y0 ][ 1 ][ 1 ] = 0 | |
| MvdCpL1[ x0 ][ y0 ][ 2 ][ 0 ] = 0 | |
| MvdCpL1[ x0 ][ y0 ][ 2 ][ 1 ] = 0 | |
| } else { | |
| if( sym_mvd_flag[ x0 ][ y0 ] ) { | |
| MvdL1[ x0 ][ y0 ][ 0 ] = −MvdL0[ x0 ][ y0 ][ 0 ] | |
| MvdL1[ x0 ][ y0 ][ 1 ] = −MvdL0[ x0 ][ y0 ][ 1 ] | |
| } else | |
| mvd_coding( x0, y0, 1, 0 ) | |
| if( MotionModelIdc[ x0 ][ y0 ] > 0 ) | |
| mvd_coding( x0, y0, 1, 1 ) | |
| if(MotionModelIdc[ x0 ][ y0 ] > 1 ) | |
| mvd_coding( x0, y0, 1, 2 ) | |
| } | |
| mvp_l1_flag[ x0 ][ y0 ] | ae(v) |
| } else { | |
| MvdL1[ x0 ][ y0 ][ 0 ] = 0 | |
| MvdL1[ x0 ][ y0 ][ 1 ] = 0 | |
| } | |

When SMVD is enabled, as mentioned in the SMVD coding section, the reference indices for list-0 and list-1 are set equal to the pair of reference pictures, respectively and MVD1 is set equal to (−MVD0) without additional signalling. To improve the performance of those kinds of short-cut tools, a derivation process using template is proposed to be performed at both encoder and decoder sides in this invention. The key idea behind the present invention is to extend the choices of possible MVD and using template matching to help select a final MVD candidate among a set of MVD candidates so as to avoid or reduce signalling overhead. In particular, the matching cost based on the template of the current block and the corresponding template of a reference block can be evaluated and used for ranking the MVD candidates. An MVD that achieves a minimum cost can be selected as the final MVD. The template shown in FIG. 22 includes a top template and a left template. Nevertheless, the template in general covers some neighbouring samples of the current block that have been already coded. Similarly, the corresponding template of the reference block covers neighbouring samples of the reference block.

For each MVD candidate, a matching cost is calculated between the template of the current block and a reference block determined according to the MVD candidate and the MVP. In other words, the reference block is located according to a MV candidate and the current block location, where the MV candidate is determined based on the MVD candidate and the MVP. Similarly, the MV candidate is also used to locate the corresponding template of the reference block.

In the following, we use the short-cut tool to be SMVD as an example. However, the use of SMVD should not be construed as a limitation to the present invention. The present invention can be applied to uni-prediction or bi-prediction. For example, the present invention can be used for any uni-prediction or bi-prediction inter tools mentioned in the standard or above mentioned inter tools. When applying to MHP, CIIP, and/or GPM, at least one motion for a pre-defined direction (list 0 or list 1) and/or at least one motion for one or more pre-defined hypotheses of prediction are refined with the present invention. When applying to affine or sub-block inter prediction modes, at least one motion for a pre-defined direction (list 0 or list 1) and/or at least one motion for one or more pre-defined subblocks are refined with the present invention. When applying to BCW, at least one motion for a pre-defined direction (list 0 or list 1) is refined with the present invention. When applying to MMVD, at least one motion (referring a MVD distance (or offset) and/or a MVD direction) for a pre-defined direction (list 0 or list 1) is refined with the present invention. When both motions for list 0 and list 1 are refined with the present invention, an order is pre-defined to refine list 0 and then refine list 1 by using or not using the refined list 0, or to refine list 1 and then refine list 0 by using or not using the refined list 1.

In one embodiment, according to MVD0 which is explicitly signalled or parsed at encoder or decoder respectively, a candidate set is pre-defined. Then, depending on the derivation process, one candidate from the candidate set is selected as the MVD1 for the current block.

In one sub-embodiment, the derivation process refers to template matching. The candidate from the candidate set with the smallest template matching error is selected as the MVD1 for the current block.

In another sub-embodiment, the candidate set depends on the signalled/parsed information from list 0. For example, the candidate set depends on MVD0, where the MVD0 herewith is also called initial MVD.

In another sub-embodiment, the candidate set includes −2MVD0, −(½)*MVD0, 0, (½)*MVD0, 2*MVD0, or any subset of the mentioned candidates.

In another sub-embodiment, the candidate set includes −2MVD0, −MVD0, −(½)*MVD0, 0, (½)*MVD0, MVD0, 2*MVD0, or any subset of the mentioned candidates.

In another sub-embodiment, the candidate set includes −4MVD0, −2MVD0, −MVD0, −(½)*MVD0, −(¼)*MVD0, 0, (¼)*MVD0, (½)*MVD0, MVD0, 2MVD0, 4MVD0, or any subset of the mentioned candidates.

In another sub-embodiment, the candidate set includes −kMVD0, −(k/2)*MVD0, −(k/4)*MVD0, . . . , −MVD0, . . . , −(1/k)*MVD0, 0, (1/k)*MVD0, . . . . MVD0, 2MVD0, 4MVD0, . . . , kMVD0, or any subset of the mentioned candidates. k is a positive integer. For example, k=16, the candidate set includes −16MVD0, −8MVD0, −4MVD0, −2MVD0, −MVD0, −(½)*MVD0, −(¼)*MVD0, −(⅛)*MVD0, −( 1/16)*MVD0, 0, ( 1/16)*MVD0, (⅛)*MVD0, (¼)*MVD0, (½)*MVD0, MVD0, 2MVD0, 4MVD0, 8MVD0, 16MVD0, or any subset of the mentioned candidates.

In another sub-embodiment, the candidate set includes −MVD0+b and −MVD0-b, where b can be any value in a pre-defined search range, or any subset of the mentioned candidates. For example, b can be dependent on the candidate index as specified Table 6.

TABLE 6
Dependence of b on the candidate index

| Candidate index | 0 | 1 | 2 | 3 | 4 | 5 | 6 | 7 |
|---|---|---|---|---|---|---|---|---|
| b (in unit of luma | ¼ | ½ | 1 | 2 | 4 | 8 | 16 | 32 |
| sample) | | | | | | | | |

In another embodiment, a candidate set (including sign information) is pre-defined. Then, depending on the derivation process, one candidate from the candidate set is selected to decide the sign used in MVD1 derivation.

In one sub-embodiment, the candidate set includes positive sign and negative sign. If positive sign is selected, MVD1 is set as k*MVD0; otherwise, MVD1 is set as −k*MVD0. For example, k is predefined as 1. For another example, k is decided by explicit signalling at the block level, SPS-level, PPS-level, APS-level, PH-level, and/or SH-level syntax. For another example, k is decided by an implicit derivation process.

In another sub-embodiment, the derivation process refers to template matching. The candidate (from the candidate set) with the smallest template matching error is selected.

In another embodiment, a candidate set is pre-defined. Then, depending on the derivation process, one candidate from the candidate set is selected to decide MVD0 and MVD1 for the current block.

In another sub-embodiment, the candidate set includes −k*delta, −(k/2)*delta, −(k/)4*delta, . . . , −delta, . . . , −(1/k)*delta, 0, (1/k)*delta, . . . delta, 2*delta, 4*delta, . . . , k*delta, or any subset of the mentioned candidates. k is a positive integer. For example, k=16: the candidate set includes −16*delta, −8*delta, −4*delta, −2*delta, −delta, −(½)*delta, −(¼)*delta, −(⅛)*delta, −( 1/16)*delta, 0, ( 1/16)*delta, (⅛)*delta, (¼)*delta, (½)*delta, delta, 2*delta, 4*delta, 8*delta, 16*delta, or any subset of the mentioned candidates. The delta can be any value within a predefined search range.

In another sub-embodiment, the candidate set includes a and −a. (or any subset of the mentioned candidates) can be dependent on the candidate index as specified the Table 7.

TABLE 7
Dependence of a on the candidate index

| Candidate index | 0 | 1 | 2 | 3 | 4 | 5 | 6 | 7 |
|---|---|---|---|---|---|---|---|---|
| a (in unit of luma | ¼ | ½ | 1 | 2 | 4 | 8 | 16 | 32 |
| sample) | | | | | | | | |

In another sub-embodiment, the candidate set varies according to AMVR for the current block.

In another sub-embodiment, MVD0 and MVD1 for the current block are set as (MVD0+the selected candidate) and (−MVD0—the selected candidate).

In another sub-embodiment, the derivation process refers to template matching. The candidate (from the candidate set) with the smallest template matching error is selected.

Template matching error can be the distortion calculated by SATD (Sum of Absolute Transformed Difference), SAD (Sum of Absolute Difference), MSE (Mean Squared Error), SSE (Sum of Squared Error), or any distortion measurement equations/metrics. For example, the template matching in this invention is shown as follows.
Step1: A template (or neighbouring region of the current block, which was encoded or decoded before the current block) is used to measure the cost for each candidate.
Step2: For each candidate, a template cost (template matching error) is calculated by the distortion between the “prediction” and reconstruction of the template.
   The “prediction” is generated by applying the short-cut mode (e.g. SMVD) with motion or MVD (using the candidate) to the template.

The proposed methods in this invention can be enabled and/or disabled according to implicit rules (e.g. block width, height, or area) or according to explicit rules (e.g. syntax on block, tile, slice, picture, SPS, or PPS level). For example, the proposed method is applied when the block area is larger than a threshold. For another example, the proposed method is applied when the longer block side is larger than or equal to a threshold (e.g. 2) multiplied by the shorter block side.

The term “block” in this invention can refer to TU/TB, CU/CB, PU/PB, a predefined region, or CTU/CTB.

AMVP in this invention is similar to “AMVP” in JVET-T2002 (Jianle Chen, et. al., “Algorithm description for Versatile Video Coding and Test Model 11 (VTM 11)”, Joint Video Experts Team (JVET) of ITU-T SG 16 WP 3 and ISO/IEC JTC 1/SC 29, 20th Meeting, by teleconference, 7-16 Oct. 2020, Document: JVET-T2002). AMVP motion is from a motion candidate with syntax “merge flag” equal to false. (e.g. general_merge_flag in VVC equal to false).

Any combination of the proposed methods in this invention can be applied. For example, although the embodiment that the candidate set depends on MVD0 and the embodiment that the candidate from the candidate set with the smallest template matching error is selected as the MVD1 for the current block are described separately, the combination of these two embodiments apparently fall within the scope of this invention. For example, one embodiment is that a candidate set is pre-defined and depending on the derivation process, one candidate from the candidate set is selected to derive the MVDs for list 0 and/or list 1 for the current block, and another embodiment is to apply to MMVD. The combination of the two embodiments will be the MMVD offsets and/or directions (used in deriving the MVDs for list 0 and/or list 1 of the current MMVD-coded block) are refined by testing more candidate refinement positions and refinement directions which are not directly indicated by the MMVD signalling, but pre-defined in the candidate set insetad. When defining the candidate set, the MMVD signalling related to the MMVD offsets and/or directions may be considered or not considered to derive the candidates in the candidate set.

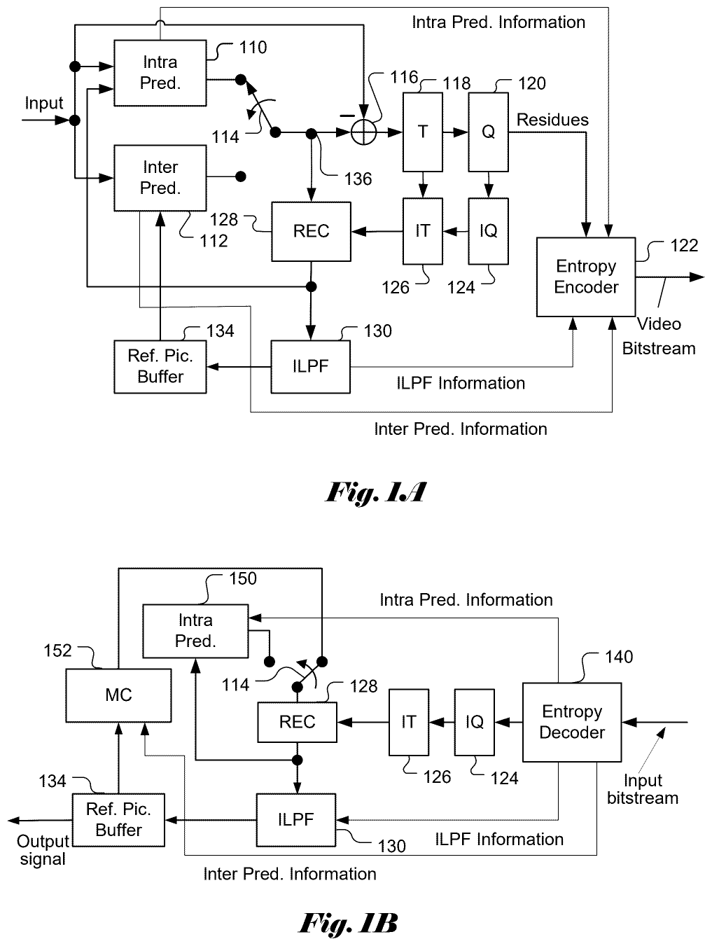

Any of the foregoing proposed adaptive predictor blending methods for coding tool using blended predictors can be implemented in encoders and/or decoders. For example, the blended predictors correspond to two intra predictors or a mix of intra and inter predictors, which can be implemented in an inter/intra/prediction module of an encoder, and/or an inter/intra/prediction module of a decoder. For example, in the encoder side, the required processing can be implemented as part of the Inter-Pred. unit 112 and/or Intra Pred. unit 110 as shown in FIG. 1A. However, the encoder may also use additional processing unit to implement the required processing. For the decoder side, the required processing can be implemented as part of the MC unit 152 and/or or Intra Pred. 150 as shown in FIG. 1B. However, the decoder may also use additional processing unit to implement the required processing. Alternatively, any of the proposed methods can be implemented as a circuit coupled to the inter/intra/prediction module of the encoder and/or the inter/intra/prediction module of the decoder, so as to provide the information needed by the inter/intra/prediction module. While the Inter-Pred. 112 and Intra Pred. 110 in the encoder side and MC 152 and Intra Pred. 150 in the decoder side are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

FIG. 23 illustrates a flowchart of an exemplary video coding system that utilizes template matching to select a MVD among a set of MVD candidates according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, data associated with a current block at an encoder side or coded data associated with the current block to be decoded at a decoder side are received in step 2310, where the current block is coded using uni-prediction or bi-prediction. At least one of a first MVP (Motion Vector Predictor) and a second MVP for the current block is determined in step 2320. At least one of a first MVD (MV Difference) associated with the first MVP and a second MVD associated the second MVP from at least one pre-defined set of MVD candidates is determined based on matching costs in step 2330. The step 2330 comprises two paths 2332 and 2334 for uni-prediction and bi-prediction respectively. In step 2332, each of the matching costs is determined between one or more neighbouring samples of the current block and one or more predicted samples from one or more corresponding neighbouring samples of each reference block pointed by a uni-prediction candidate MV based on a candidate of said at least one pre-defined set of MVD candidates and one of the first MVP and the second MVP. In step 2334, each of the matching costs is determined between one or more neighbouring samples of the current block and one or more predicted samples from one or more corresponding neighbouring samples of each reference block pointed by a bi-prediction candidate MV based on at least the first MVP, the second MVP, and a candidate of said at least one pre-defined set of MVD candidates. The current block is encoded or decoded by using motion information comprising at least one of a first final MV associated with the first MVP and the first MVD, and a second final MV associated with the second MVP and the second MVD in step 2340.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of video coding, the method comprising:
receiving input data associated with a current block, wherein the input data comprise pixel data for the current block to be encoded at an encoder side or encoded data associated with the current block to be decoded at a decoder side, and wherein the current block is coded using uni-prediction or bi-prediction;
determining at least one of a first MVP (Motion Vector Predictor) and a second MVP for the current block;
determining at least one of a first MVD (MV Difference) associated with the first MVP and a second MVD associated with the second MVP from at least one pre-defined set of MVD candidates based on matching costs, comprising at least one of the following:
in response to the current block being coded using the uni-prediction, each of the matching costs is determined between one or more neighbouring samples of the current block and one or more predicted samples from one or more corresponding neighbouring samples of each reference block pointed by a uni-prediction candidate MV based on a candidate of said at least one pre-defined set of MVD candidates and one of the first MVP and the second MVP;
in response to the current block being coded using the bi-prediction, each of the matching costs is determined between one or more neighbouring samples of the current block and one or more predicted samples from one or more corresponding neighbouring samples of each reference block pointed by a bi-prediction candidate MV based on at least the first MVP, the second MVP, and a candidate of said at least one pre-defined set of MVD candidates; and
encoding or decoding the current block by using motion information comprising at least one of a first final MV associated with the first MVP and the first MVD, and a second final MV associated with the second MVP and the second MVD.

2. The method of claim 1, wherein in response to the current block being coded using the uni-prediction, the uni-prediction candidate MV achieving a smallest matching cost is selected to derive said at least one of the first final MV and the second final MV.

3. The method of claim 1, wherein in response to the current block being coded using the bi-prediction, the bi-prediction candidate MV achieving a smallest matching cost is selected to derive said at least one of the first final MV and the second final MV.

4. The method of claim 1, wherein in response to the current block being coded using the uni-prediction, said at least one pre-defined set of MVD candidates corresponds to only one pre-defined set of MVD candidates used for deriving the uni-prediction candidate MV in list 0 or list 1.

5. The method of claim 1, wherein in response to the current block being coded using the bi-prediction, said at least one pre-defined set of MVD candidates corresponds to only one pre-defined set of MVD candidates used for deriving the bi-prediction candidate MV.

6. The method of claim 1, wherein in response to the current block being coded using the bi-prediction, said at least one pre-defined set of MVD candidates corresponds to two separate pre-defined sets of MVD candidates used for deriving list 0 MV in the bi-prediction candidate MV and list 1 MV in the bi-prediction candidate MV respectively.

7. The method of claim 1, wherein in response to the current block being coded using the uni-prediction or the bi-prediction, one or more candidates in said at least one pre-defined set of MVD candidates are derived from an initial MVD.

8. The method of claim 7, wherein the initial MVD for list 0 or list 1 is signalled or parsed.

9. The method of claim 7, wherein said at least one pre-defined set of MVD candidates comprises one or more candidate members determined based on one or more signs of the initial MVD, one or more values of the initial MVD or both.

10. The method of claim 9, wherein said one or more signs of the initial MVD correspond to plus sign and minus sign.

11. The method of claim 9, wherein said one or more values of the initial MVD correspond to k*(the initial MVD) or 0, and wherein k corresponds to N or 1/N, and N is a positive integer.

12. The method of claim 9, wherein said one or more values of the initial MVD correspond to (the initial MVD)±b, and wherein b corresponds to an integer or a fractional number.

13. The method of claim 7, wherein said at least one pre-defined set of MVD candidates comprises one or more candidate members determined based on one or more signs of the initial MVD, and wherein a sign for a target MVD candidate is determined from said at least one pre-defined set of MVD candidates based on the matching costs.

14. The method of claim 13, wherein a value for the target MVD candidate is predefined.

15. The method of claim 13, wherein a value for the target MVD candidate is signalled or parsed.

16. The method of claim 15, wherein one or more syntaxes related to the value for the target MVD candidate are signalled or parsed at a block level, SPS-level, PPS-level, APS-level, PH-level, SH-level or a combination thereof.

17. The method of claim 1, wherein the matching costs correspond to distortion between said one or more neighbouring samples of the current block and one or more corresponding neighbouring sample of each reference block, and wherein the distortion is measured using one or more metrics comprising SATD, SAD, MSE or SSE.

18. An apparatus for video coding, the apparatus comprising one or more electronics or processors arranged to:
receive input data associated with a current block, wherein the input data comprise pixel data for the current block to be encoded at an encoder side or encoded data associated with the current block to be decoded at a decoder side, and wherein the current block is coded using uni-prediction or bi-prediction;
determine at least one of a first MVP (Motion Vector Predictor) and a second MVP for the current block;
determine at least one of a first MVD (MV Difference) associated with the first MVP and a second MVD associated with the second MVP from at least one pre-defined set of MVD candidates based on matching costs, comprising at least one of the following:
in response to the current block being coded using the uni-prediction, each of the matching costs is determined between one or more neighbouring samples of the current block and one or more predicted samples from one or more corresponding neighbouring samples of each reference block pointed by a uni-prediction candidate MV based on a candidate of said at least one pre-defined set of MVD candidates and one of the first MVP and the second MVP;
in response to the current block being coded using the bi-prediction, each of the matching costs is determined between one or more neighbouring samples of the current block and one or more predicted samples from one or more corresponding neighbouring samples of each reference block pointed by a bi-prediction candidate MV based on at least the first MVP, the second MVP, and a candidate of said at least one pre-defined set of MVD candidates; and
encode or decode the current block by using motion information comprising at least one of a first final MV associated with the first MVP and the first MVD, and a second final MV associated with the second MVP and the second MVD.
